(19) United States
(12) Patent Application Publication
(10) Pub. No.: US 2009/0192812 A1
(43) Pub. Date: Jul. 30, 2009

(54) Wall Street Rating System, Method, and Apparatus

(76) Inventor: Glenn C. Hurowitz, Washington, DC (US)

Correspondence Address: MAXVALUEIP CONSULTING, 11204 ALBERMYRTLE ROAD, POTOMAC, MD, 20854, US

(21) Appl. No.: 12/021,197

(22) Filed: Jan. 28, 2008

(51) Int. Cl. G06F 17/00

(52) U.S. Cl. 705/1

(57) ABSTRACT

While several services offer ratings of different investment firms, these have little value when it comes to evaluating the actual quality of the individuals an investor or businessman will be working with. Given the vast size of the financial services firms, and the wide variation in their employees, the quality of the individual is often far more important than the identity of their employer. That is as true for the individual seeking an investment advisor as the business seeking a trustworthy team to manage their merger, acquisition, or IPO. As a result, individuals and businesses too often have to rely on the word of mouth information from other people (friends and family members) who do not have good grounds for comparison, and who may provide recommendations to help out their investment advisor, or to give the impression that they are achieving high rates of return. Our current service (solution) addresses this problem and need. There is no other service or procedure available that has the elements similar to ours, mentioned here.

### BACKGROUND

Choosing an investment advisor, stock broker, or banker is one of the most important financial decisions people make. The ability and honesty of that person can be the single most important factor in determining an individual or corporation's financial future. Yet, sources of information about financial services professionals are limited, and concentrated in the era of Web 1.0.

Some of the prior art are:

In Finance:

http://www.morningstar.com

http://www.brokeradviser.com/?kw=Broker%20Review&r=GG_kwBrokerReview

http://forums.babypips.com/rate-my-broker/

http://www.rateyours.com/serendipity/archives/14-Mortgage-brokers-Have-you-had-a-good-or-bad-experience-with-a-mortgage-broker.html#extended

http://www.wallstreetselect.com/directory/index.php?c=2&gclid=CPbfyYPmmo0 CFRUHWAodsyPY6Q

http://www.wrapmanager.com/managers_listing.php?utm_source=GGL&utm_medium=PPC&utm_term=money%2Bmanagers&utm_content=Money%2BManager%2BComparison&utm_{—}campaign=WrapManager&gclid=CO2vsqXmmo0CFQGPWAodyHNm6A

http://www.managerreview.com/index.php?file=c-man_report

http://www.advisornow.com/kiosk/consumer

In Gyms:

http://gymlocator.com/

http://www.t-nation.com

http://www.ratemyeverything.com

Also, a patent as prior art: U.S. Pat. No. 7,277,864, Ohnemus, et al., Oct. 2, 2007, Sustainability ratings and benchmarking for legal entities.

However, none of the above covers the features mentioned in the current invention, shown below.

### SUMMARY

While several services offer ratings of different investment firms, these have little value when it comes to evaluating the actual quality of the individuals an investor or businessman will be working with. Given the vast size of the financial services firms, and the wide variation in their employees, the quality of the individual is often far more important than the identity of their employer. That's as true for the individual seeking an investment advisor as the business seeking a trustworthy team to manage their merger, acquisition, or IPO. As a result, individuals and businesses too often have to rely on the word of mouth information from other people (friends and family members) who do not have good grounds for comparison, and who may provide recommendations to help out their investment advisor, or to give the impression that they are achieving high rates of return. The current invention addresses this problem and need, by providing rating and comments for individuals in those positions.

### BRIEF DESCRIPTION OF THE DRAWINGS

FIG. 1 shows a typical/example of the system of the current invention (different modules).

FIG. 2 shows a typical/example of the system of the current invention (different steps).

### DETAILED DESCRIPTION OF THE PREFERRED EMBODIMENTS

Our solution, WallStreetRater.com, solves this problem, by bringing the on-line ratings revolution to the financial services industry. It will give users the opportunity to rate people working in the financial services industry—investment advisors, stock brokers, money managers, investment bankers and others—and find out what others are saying. It is an investor's Zagat's—and as such, way more valuable than any of the other ratings services that exist.

There is vast potential for this kind of service. One of the more popular websites for rating professionals, RateMyTeachers.com, includes more than 10,000,000 ratings of almost 1.5 million teachers. Given how much is riding on the selection of a financial advisor, we expect not only high numbers of users—but also high numbers of high-value users: the kind that will attract high-paying advertisers. And as several other ratings services have proven, people are eager to give both positive and negative feedback—publicly—to the professionals providing them important services. What's more, the professionals themselves often become the best marketers for ratings services by asking their clients to rate them.

That will encourage the professionals to use this service, and read all the feedback and ratings, to adjust and improve their performance in the future, to become more competitive in the market. Overall, the feedback improves the quality and performance of the individuals and the industry, as a whole.

How the Service Works:

There will be three types of site users: raters, rating reviewers (potential financial services customers), and the financial services professionals, themselves. Raters will be able to offer their feedback in five (or more) categories (for example) and provide an overall rating, as well. Perhaps, most importantly, they will be able to provide detailed, qualitative commentary on those they are rating.

Categories for investment advisors and brokers will be, as an example:

1) Annual Return

2) Fees

3) Honesty

4) Responsiveness

5) Working experience

6) Conflict-of-interest

7) Past performance

8) Education

9) Size of the firm

10) Size of the investment

11) Types of industries

Categories for investment bankers and other financial service professionals will be, as an example:

1) Overall

2) Delivers Financial Value

3) Creativity

4) Responsiveness

5) Honesty

6) Working Experience

They are able to classify themselves by sector, and industry, and investment style. For instance, if they focus on international stocks, the technology sector, or value stocks, they will be able to indicate that in their profiles.

Finally, to drive significant traffic to the site—and get those users to spend time on the site—we invite financial professionals to post their own profiles on the website. They will be able to offer detailed information about their 1, 3, and 5 year rates of return, their investing strategies, and any other information they want to supply. It will be a way for them to advertise to interested people.

Search:

Users will be able to search by a number of categories:

1) Type (investment advisor, stock broker, investment banker, trader, analyst, accountant etc.)

2) Investing Style (Capital Preservation, Income, Growth, Speculation)

3) Sector (Stocks—Domestic/International, by region & country), Fixed Income, Commodities, Government Bonds, Industry (Basic Materials, Consumer Services, Consumer Goods, Energy, Financial, Healthcare, Industrial, Natural Resources, Technology, Telecommunications, Transportation, Utilities, Real Estate).

Extras:

Wall Street Hotties Rater: As a way to stimulate traffic to the site, the site will feature a “hotties” rater where people can rate the physical appearance (“hotness”) of different financial services professionals who submit (clothed) photos to the site (featured on the websites www.wallstreethotties.com and www.wallstreethotty.com, as well).

News Feed: WallStreetRater will partner with a financial news service to provide financial news and content for users.

How the Service will Make Money:

Initially, the service will be driven by advertising. We believe advertisers will be willing to pay a substantial premium for access to eyeballs of people looking for investment advisors and other financial professionals.

After the beta testing period, we will consider charging fees to financial service professionals to be listed on the website.

In one embodiment, the database for all the ratings is on a central repository. In another embodiment, the information is kept on a distributed network. In one embodiment, the information and ratings are based on voting schemes, such as majority of votes, or super-majority of the votes. In one embodiment, the name of the rating person is visible, and the comments can be added to the ratings by any party. In one embodiment, the names are hidden. In one embodiment, the ratings are updated every year or month (or discarded). In one embodiment, the weighted average of the ratings is calculated.

In one embodiment, a person can challenge the rating party. In one embodiment, there is an arbitrator for solving the discrepancies. In one embodiment, the services are for free. In one embodiment, the fees are charged against one or more parties. In one embodiment, the credentials are verified. In one embodiment, the average for the industry is shown, for comparison.

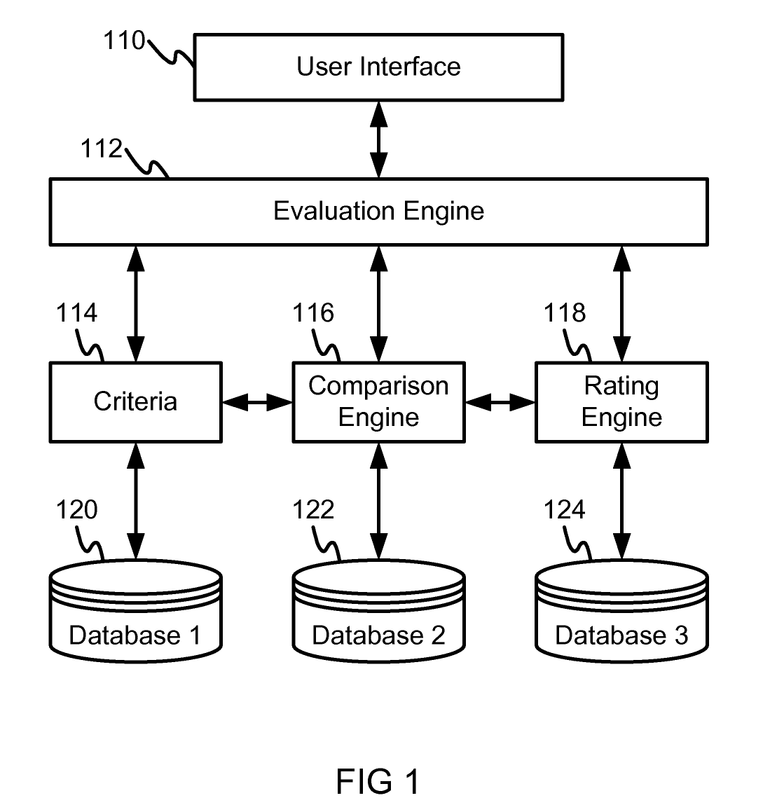

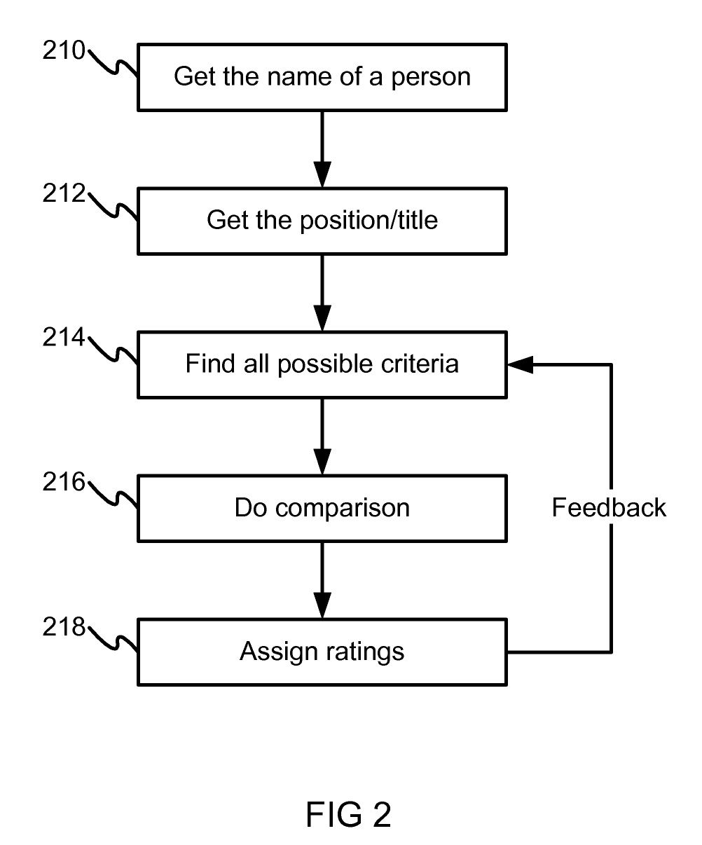

FIG. 1-2 show a typical/example of the system of the current invention. In FIG. 1, we have user interface (110), connected to evaluation engine (112), which is connected to comparison engine (116) and rating engine (118), and access the criteria (114), with all the above connecting to their corresponding databases (122, 124, 120, respectively), which can be updated or changed by feedback.

In FIG. 2, the name of the person is obtained, first (210). Then, the position/title (212) is reviewed, followed by all possible criteria (214). Next, the comparison is done (216), which results in rating assignment (218), based on a table, formula, fuzzy logic/neural network, if-conditions, ranges, predetermined recipe, guideline, instruction, procedure, or technique. The feedback can optionally be supplied to change the criteria or thresholds for conditions.

For the interface, the user can choose (as an embodiment) the selections from the menu and choose/type the name of the person, types of profession, name of the firm, paid-services, background, reviews, feedback, comments, video clips, voice clips, pictures, album, music, or pre-recorded pieces. The choices can be hierarchical and nested within another. They can have class/subclass structure.

In one embodiment, the client/server structure is used. In one embodiment, the web service is used. In one embodiment, the peer-to-peer connection is used. The comparison and rating may be different from the ones in FIGS. 1-2. The order may be different, and there are more steps in between. The double-checking and verification/authentication may be added. For example, the reviewers or comments/feedback may be filtered or edited by unbiased third party, as the judge. The history of all the parties and credibility score can be added to the equation, for better evaluation and credibility.

In one embodiment, the person can do self-rating or nominating another person. The advertisement can be added to the web site, with links to relevant sites. One can also search for a person in a class/profession/expertise/price range/location/proximity/experience/affiliation, or combination of them. Each entity can also rate others in other classes/professions/roles, as an option.

Any variations on the teachings above are also meant to be covered by the current patent application.

1. A system for rating a person,
wherein said person is an investment advisor, financial advisor, stock broker, investment banker, trader, analyst, or accountant,
wherein said rating is based on annual return, fees, honesty, responsiveness, working experience, conflict-of-interest, past performance, education, size of the firm, or size of the investment,
said system comprising:
a database, and
a rating subsystem,
wherein a search is conducted using at least one of the following categories:
type, investing style, or sector,
wherein a user uses said system, and
wherein said user belongs to at least one of the following groups: raters, rating reviewers, or financial services professionals.

2. A system for rating a person, as recited in claim 1, wherein said type for conducting a search is based on one or more of the following: investment advisor, stock broker, investment banker, trader, analyst, or accountant.

3. A system for rating a person, as recited in claim 1, wherein said investing style for conducting a search is one or more of the following: capital preservation, income, growth, or speculation.

4. A system for rating a person, as recited in claim 1, wherein said sector for conducting a search is based on one or more of the following: domestic or international stocks, by region or country, fixed income, commodities, government bonds, or industry.

5. A system for rating a person, as recited in claim 4, wherein said industry for conducting a search is based on one or more of the following: basic materials, consumer services, consumer goods, energy, financial, healthcare, industrial, natural resources, technology, telecommunications, transportation, utilities, or real estate.

6. A system for rating a person, as recited in claim 1, wherein said raters offer their feedback in one or more categories.

7. A system for rating a person, as recited in claim 1, wherein said raters offer their feedback in one overall rating evaluation.

8. A system for rating a person, as recited in claim 1, wherein said user provides comments.

9. A system for rating a person, as recited in claim 1, wherein said user provides comments on other people's comments or ratings.

10. A system for rating a person, as recited in claim 1, wherein said raters are rated by others.

11. A system for rating a person, as recited in claim 1, wherein said system comprises an encryption, security, or biometrics module.

12. A system for rating a person, as recited in claim 1, wherein said system is regulated or judged by an arbitrator.

13. A system for rating a person, as recited in claim 1, wherein said user challenges a rating result.

14. A system for rating a person, as recited in claim 1, wherein said system provides one or more detailed qualitative commentaries with different weights on said person.

15. A system for rating a person, as recited in claim 1, wherein said system outputs a single number for the rating.

16. A system for rating a person, as recited in claim 1, wherein said system uses one or more of the following for the rating assignment: a table, formula, fuzzy logic, neural network, if-conditions, ranges, predetermined recipe, guideline, instruction, procedure, or technique.

17. A system for rating a person, as recited in claim 1, wherein said system is based on dynamic parameters.

18. A system for rating a person, as recited in claim 1, wherein said system hides the identity of said user.

19. A system for rating a person, as recited in claim 1, wherein said system is fee-based, subscription-based, or advertisement-based.

20. A system for rating a person, as recited in claim 1, wherein said system interacts with, or is connected to, a cell phone, PDA, computer, I-Pod, news-feed, broadcasting element, or Internet web site.
